(19) United States
(12) Patent Application Publication
(10) Pub. No.: US 2008/0141901 A1
(43) Pub. Date: Jun. 19, 2008

(54) ADDITIVES TO STABILIZE CYCLOTETRASILOXANE AND ITS DERIVATIVES

(75) Inventors: Mindi Xu, Naperville, IL (US); Trapti Chaubey, Wilmington, DE (US)

Correspondence Address: AIR LIQUIDE;Intellectual Property, 2700 POST OAK BOULEVARD, SUITE 1800, HOUSTON, TX, 77056, US

(73) Assignee: AMERICAN AIR LIQUIDE, INC., Houston, TX (US)

(21) Appl. No.: 11/830,607

(22) Filed: Jul. 30, 2007

Related U.S. Application Data
(60) Provisional application No. 60/870,483, filed on Dec. 18, 2006.

(51) Int. Cl. C08L 83/06; C08K 5/09; C08K 5/101

(52) U.S. Cl. 106/287.1; 524/284

(57) ABSTRACT

Novel methods and additives for stabilizing one or more cyclotetrasiloxane compounds for use in silicon film deposition are described herein. The disclosed methods and additives may utilize silicon-containing compounds to inhibit polymerization of one or more cyclotetrasiloxanes. In an embodiment, a method of stabilizing one or more cyclotetrasiloxane compounds for use in silicon film deposition comprises adding one or more additives to the one or more cyclotetrasiloxane compounds to inhibit polymerization of the cyclotetrasiloxane compound. The one or more additives may comprise an acrylate, a methacrylate, or a silane compound having the formula:

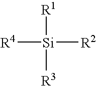

where R¹-R⁴ may each independently be an alkyl group, an alkoxy group, a heterocyclic group, an acryloxy group, a vinyl group, an epoxy group, a glycidyloxy group, or a hydrogen. R¹-R⁴ may be the same or different from each other. The one or more additives may also comprise combinations of the above mentioned compounds.

### CROSS-REFERENCE TO RELATED APPLICATIONS

The present application claims the benefit of U.S. Provisional Application Ser. No. 60/870,483, filed Dec. 18, 2006, herein incorporated by reference in its entirety for all purposes.

### BACKGROUND

1. Field of the Invention

This disclosure relates generally to compounds used in semiconductor fabrication. More specifically, the disclosure relates to compositions and methods of stabilizing cyclotetrasiloxane compounds.

2. Background of the Invention

Silicon-containing dielectric deposition is commonly used in the fabrication of integrated circuits. In particular, silicon dioxide films are used extensively in the fabrication of integrated circuits and semiconductor devices. Methods and compounds for depositing silicon dioxide films are well known in the art such as chemical vapor deposition (CVD) or plasma enhanced chemical vapor deposition. Several silicon-containing compounds have been identified as being useful for the deposition of dielectric (low-k) films in the semiconductor manufacturing including without limitation, tetramethylsilane and dimethyldimethoxysilane. When these silicon-containing compounds are used for film deposition, they are typically delivered from a chemical container to a vaporizer for delivery to a deposition chamber.

One class of silicon-containing compounds that may be used in silicon film deposition are cyclotetrasiloxane compounds. Such compounds have been shown to exhibit superior silicon dioxide deposition properties when compared to traditional silicon-containing precursors such as silanes. For example, cyclotetrasiloxane compounds possess higher volatility allowing the dielectric films to be deposited at lower temperatures with greater efficiency.

However, cyclotetrasiloxane compounds do have some limitations. When cyclotetrasiloxane compounds such as tetramethyl cyclotetrasiloxane (TMCTS) and octamethyl cyclotetrasiloxane (OMCTS) are used for film deposition, a general problem that arises is the polymerization of these compounds during transportation or delivery. The clogging or blockage of lines or channels in equipment causes expensive delays and also may present safety issues due to pressure build-up in the lines.

Consequently, there is a need for additives for stabilizing or inhibiting the polymerization of cyclotetrasiloxane compounds.

### BRIEF SUMMARY

Novel methods and additives for stabilizing one or more cyclotetrasiloxane compounds for use in silicon film deposition are described herein. The disclosed methods and additives may utilize silicon-containing compounds to inhibit polymerization of one or more cyclotetrasiloxanes.

In an embodiment, a method of stabilizing one or more cyclotetrasiloxane compounds for use in silicon film deposition comprises adding one or more additives to the one or more cyclotetrasiloxane compounds to inhibit polymerization of the cyclotetrasiloxane compound. The one or more additives may comprise an acrylate, a methacrylate, or a silane compound having the formula:

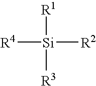

where R¹-R⁴ may each independently be an alkyl group, an alkoxy group, a heterocyclic group, an acryloxy group, a vinyl group, an epoxy group, a glycidyloxy group, or a hydrogen. R¹-R⁴ may be the same or different from each other. The one or more additives may also comprise combinations of the above mentioned compounds.

In another embodiment, a silicon film deposition composition comprises a mixture of one or more cyclotetrasiloxane compounds and one or more additives comprising an acrylate, a methacrylate, or a silane having the formula:

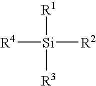

where R¹-R⁴ may each independently be an alkyl group, an alkoxy group, a heterocyclic group, an acryloxy group, a vinyl group, an epoxy group, a glycidyloxy group, or a hydrogen. R¹-R⁴ may be the same or different from each other. The one or more additives may also comprise combinations of the aforementioned compounds.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a gas chromatography spectrum (GC) for tetramethylcyclotetrasiloxane (TMCTS) by itself;

FIG. 2 is a GC chromatogram for an aged TMCTS sample at 110° C. for 7 days

FIG. 3 is a plot of the area counts for TMCTS samples heated at 110° C. for 7 days;

FIGS. 4A-B show plots of viscosity measurements of TMCTS samples heated at 110° C. for 7 days A) without water and B) with water;

FIGS. 5A-B show plots of viscosity measurements of TMCTS samples heated at 132° C. for 7 days A) without water and B) with water; and

FIGS. 6A-B show plots of viscosity measurements of TMCTS samples at various concentrations heated at 132° C. for 7 days A) without water and B) with water.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”.

### DETAILED DESCRIPTION OF THE EMBODIMENTS

In embodiments, a method of inhibiting the polymerization (i.e. stabilizing) of one or more cyclotetrasiloxane compounds comprises adding one or more of the novel additives described herein. As used herein, a cyclotetrasiloxane compound is any compound having the following formula:

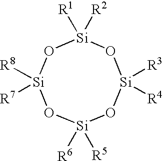

Where R¹-R⁸ may independently be an alkyl group or hydrogen. R¹-R⁸ may be the same or different from one another. In embodiments, R¹-R⁸ may all comprise the same functional group. The alkyl group may be branched or unbranched. In addition, R¹-R⁸ may independently be an alkyl group having from 1 to 10 carbon atoms, alternatively from 1 to 8 carbon atoms, alternatively from 1 to 4 carbon atoms. In particular embodiments, the cyclotetrasiloxane compounds may be unsubstituted cyclotetrasiloxane, octamethyl cyclotetrasiloxane, tetramethyl cyclotetrasiloxane, or combinations thereof.

Without being limited by theory, the polymerization or gelation of cyclotetrasiloxane compounds is believed to be caused by the reaction of cyclotetrasiloxane materials with oxidized substances or oxidizers. The polymerization reaction normally requires a catalyst such as a base, a strong acid, a radical, metals or transition metal complexes. The hydrogens and/or hydrogen radicals in the cyclotetrasiloxane compounds are replaced by more reactive atoms such as oxygen to form more stable and stronger chemical bonds between the atoms and silicon. It is further believed that the cyclotetrasiloxane ring is opened in the presence of oxidizers and catalysts causing the formation of long chain molecules. The polymerization process may be accelerated at elevated temperatures.

Because cyclotetrasiloxane polymerization occurs at a high temperature and the presence of a catalyzing compound, it is postulated that an inhibitor compound may have at least one reactive group to inhibit polymerization of cyclotetrasiloxane compounds. The reactive group may easily form a bond with the silicon atoms in the cyclotetrasiloxane compounds to shield the active site of the compounds from further reaction. The reactive group may also react with any compounds which catalyze the polymerization reaction to inactivate them. Since embodiments of the additives may comprise certain types of organosilicon chemicals, an advantage of the disclosed additives is that they may have a similar composition including silicon, hydrogen, and carbon atoms and may not contaminate the silicon deposition process. Therefore, embodiments of the additives preferably do not add any undesired composition to the deposited silicon film nor change the property of the deposited film.

In embodiments, a method of inhibiting polymerization of one or more cyclotetrasiloxane compounds comprises adding one or more additives comprising a silane compound, an acrylate, a methacrylate, or combinations thereof. In an embodiment, a method of inhibiting polymerization of a cyclotetrasiloxane compound comprises adding a silane compound having the following formula:

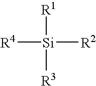

where R¹-R⁴ may each independently be an alkyl group, an alkoxy group, a heterocyclic group, an acryloxy group, a vinyl group, an epoxy group, a glycidyloxy group, or hydrogen. R¹-R⁴ may be the same or different from one another. In embodiments, R¹-R⁴ may independently be an alkyl group having from 1 to 10 carbon atoms, alternatively from 1 to 8 carbon atoms, alternatively from 1 to 4 carbon atoms. Moreover, in embodiments, R¹-R⁴ may all be the same group. In a particular embodiment, the silane compound is an alkylsilane. As used herein, an alkylsilane is a silane containing only alkyl groups. Examples of alkylsilanes that may be used in the method include without limitation, tetramethylsilane (TMS), tetraethylsilane, tetrapropylsilane, and the like. In further embodiments, the silane is a quaternary silane where R¹-R⁴ each comprise a functional group other than hydrogen.

In embodiments, the silane compound is an alkoxy silane compound where R¹-R⁴ may each independently be an alkoxy group (i.e.—O—R—, where R is an alkyl group) or a hydrogen atom. Examples of alkoxy silane compounds include without limitation, vinyltrimethoxysilane, methacryloxytrimethylsilane, or methacryloxypropyltrimethoxysilane.

In an embodiment, the silane may comprise a silicate such as without limitation, an orthosilicate. As used herein, an orthosilicate is a compound having a central silicon atom coupled to 4 oxygen atoms. The orthosilicate may have the following formula:

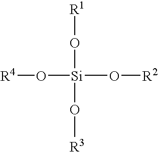

where R¹-R⁴ may each independently be an alkyl group or a hydrogen atom. R¹-R⁴ may be the same or different from one another. R¹-R⁴ may all be the same group. The alkyl groups may be branched or unbranched. In embodiments, R¹-R⁴ may independently be an alkyl group having from 1 to 10 carbon atoms, alternatively from 1 to 8 carbon atoms, alternatively from 1 to 4 carbon atoms. Examples of orthosilicates include without limitation, tetraethylorthosilicate, tetramethylorthosilicate, tetrabutylorthosilicate, tetrapropylorthosilicate, and the like.

In another embodiment, the additive comprises an acrylate or methacrylate compound. The acrylate or methacrylate compound has the formula:

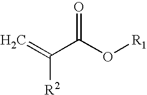

where R¹-R² may each independently be an alkyl group or a hydrogen atom. R¹-R² may be the same or different from one another. The alkyl groups may be branched or unbranched and may have from 1 to 8 carbon atoms. Examples suitable alkyl groups include without limitation, methyl groups, ethyl groups, propyl groups, isopropyl groups, butyl groups, isobutyl groups, and the like. In a particular embodiment, the acrylate may be a methacrylate where R² is a methyl group. In one embodiment, the additive comprises isobutyl methacrylate (IBM).

The inhibition or stabilization of the one or more cyclotetrasiloxanes may be quantified by measuring the change in viscosity. The one or more additives may maintain the kinematic viscosity of the one or more cyclotetrasiloxane compounds at a stable viscosity or a viscosity ranging from about 0.8 centistokes (cSt) to about 1 cSt at a temperature ranging from about 20° C. to about 132° C., preferably ranging from about 0.8 cSt to about 0.85 cSt at a temperature ranging from about 20° C. to about 132° C. Alternatively, upon addition of the one or more additives, the viscosity of the one or more cyclotetrasiloxane compounds at temperatures at least of 110° C., may maintain the viscosity to within about 5% to about 15% of the viscosity of the cyclotetrasiloxane compounds at 20° C. or room temperature, preferably within about 4% to about 6% as compared to the viscosity of the cyclotetrasiloxane compounds at 20° C. or room temperature, more preferably within about 0.5% to about 2% as compared to the viscosity of the cyclotetrasiloxane compounds at 20° C. or room temperature. Furthermore, the one or more additives may maintain viscosity at temperature of at least about 132° C.

Another measure of polymerization is by measuring the purity of the one or more cyclotetrasiloxane compounds. The one or more additives may maintain the purity of the one or more cyclotetrasiloxane compounds as measured by GC at least about 99%, preferably at least about 99.25%, more preferably at least about 99.5%. The purity of the one or more cyclotetrasiloxane compounds, as used herein, refers to the percentage of the area count of main GC peaks of the one or more cyclotetrasiloxane compounds as compared to the total area count under the GC peaks including peaks of any impurities caused by the polymerization of the cyclotetrasiloxane compounds. See, e.g., Examples 1-7 and 9 supra. Thus, for exemplary purposes only, a cyclotetrasiloxane compound may have a percentage area count of 99.5% before heating (as commercial grade purity may be 99.5%). After heating, the area under the peak may be 99.25% of the total area count which represents an increase of 0.25% in the amount of impurities, due to polymerization of the cyclotetrasiloxane compounds.

It is contemplated that in some embodiments, a combination or cocktail of additives may be added to the cyclotetrasiloxane compound to inhibit polymerization. That is, two or more additives may be added to the cyclotetrasiloxane compound. In further embodiments, the above described additives may be added to the cyclotetrasiloxane compound at any suitable concentration. More particularly, one or more additives may be added to the cyclotetrasiloxane compound at a concentration ranging from about 10 ppm by weight to about 2000 ppm by weight, alternatively from about 25 ppm by weight to about 1000 ppm by weight, alternatively from about 50 ppm by weight to about 500 ppm by weight.

In additional embodiments, the one or more additives may be used to stabilize “wet” cyclotetrasiloxane compounds or cyclotetrasiloxane compounds containing water. Moisture is often a problem which may exacerbate polymerization of the cyclotetrasiloxane compounds. Embodiments of the disclosed additives are capable of inhibiting polymerization even in the presence of water or moisture. Water may be present at a concentration ranging from about 1 ppm by weight to about 2000 ppm by weight, alternatively from about 100 ppm by weight to about 1750 ppm by weight, alternatively from about 500 ppm by weight to about 1500 ppm by weight.

To further illustrate various illustrative embodiments of the present invention, the following examples are provided.

### EXAMPLES

### Methods and Materials

Experiments were designed to test organosilicon compounds at the condition as close to the real applications as possible. Metal ampoules were constructed with electropolished stainless steel tubes to hold the chemical solutions for testing. A known amount of tetramethylcyclotetrasiloxane was added into the ampoules and then the additive to be tested was added at a predetermined concentration. After the additive was added, the ampoule was shaken to mix the cyclotetrasiloxane compound and the additive. The ampoules were then placed in an oil bath at a temperature of 110° C. for 7 days. After the testing period, the ampoules were cooled to room temperature (20° C.).

The organosilicon compounds for the tests were: 3-(methacryloxy)propyltrimethoxysilane (C₁₀H₂₀O₅Si), vinyltrimethoxysilane (C₅H₁₂O₃Si), and tetraethylorthosilicate (C₈H₂₀O₄Si), tetramethylsilane (C₄H₁₆Si).

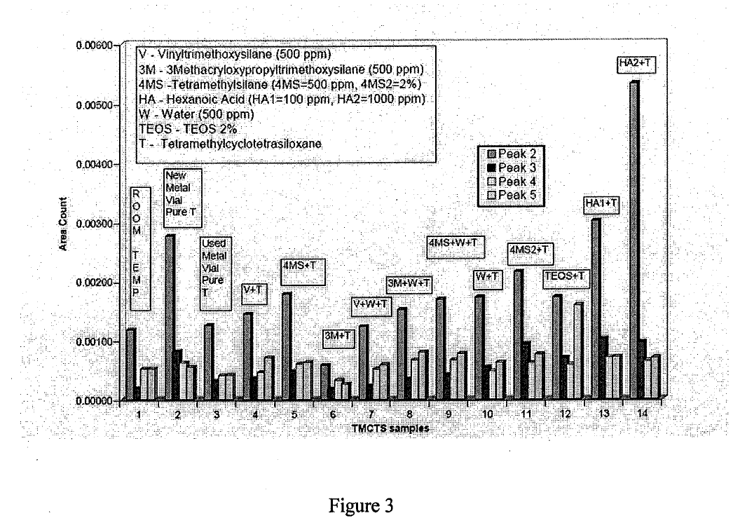

The ampoules with samples were set in a silicon oil bath that was controlled at a temperature of 110° C. continuously for 7 days. After the ampoules were removed from the hot oil bath, they were brought into a glove box to cool at room temperature. The samples in the ampoules were taken with a sampling syringe for analysis with a gas chromatography. The GC had a flame ionization detector that operated at a temperature of 225° C. The GC column was 105 meters long and 0.53 mm in diameter with a stationary phase of diphynyl/dimethyl polysiloxane. The column oven temperature was at 240° C. with a ramp of 5° C./min. Samples were injected for 1 micro liter each time to the injector controlled at 200° C. The split ratio was at the sequence that initially was off, 20 at 0.25 min, and then 10 at 0.75 min. Results from the tests are shown in Table 1 and FIG. 3.

TABLE 1
Normalized area counts for the peaks of different samples

| | Normalized Peak Count | | | |
|---|---|---|---|---|
| | Peak | Peak | Peak | Peak |
| Samples | 2 | 3 | 4 | 5 |
| TMCTS Room Temp. | 8.46 | 1.35 | 3.07 | 2.98 |
| TMCTS + 500 ppm | 14.50 | 3.65 | 4.64 | 7.11 |
| vinyltrimethoxysilane | | | | |
| TMCTS + 500 ppm 4MS | 17.88 | 4.87 | 6.06 | 6.32 |
| TMCTS + 500 ppm | 5.82 | 1.79 | 3.27 | 2.63 |
| 3Methacryloxypropyltrimethoxysilane | | | | |
| TMCTS + 500 ppm water + 500 ppm | 12.39 | 2.33 | 5.15 | 5.88 |
| vinyltrimethoxysilane | | | | |
| TMCTS + 500 ppm water + 500 ppm | 15.20 | 3.48 | 6.73 | 8.02 |
| 3-Methacryloxy propyl trimethoxysilane | | | | |
| TMCTS & 500 ppm water & 500 ppm 4MS | 16.96 | 4.21 | 6.69 | 7.80 |
| TMCTS & 500 ppm water | 17.32 | 5.47 | 4.80 | 6.28 |
| TMCTS & 2% 4MS | 21.59 | 9.39 | 6.19 | 7.66 |
| TMCTS & 2% TEOS | 17.30 | 7.04 | 5.90 | 15.94 |
| TMCTS & 100 ppm hexanoic acid | 30.17 | 10.22 | 7.09 | 7.17 |
| TMCTS & 1000 ppm hexanoic acid | 53.29 | 9.64 | 6.52 | 7.01 |

### Example 1

### TMCTS

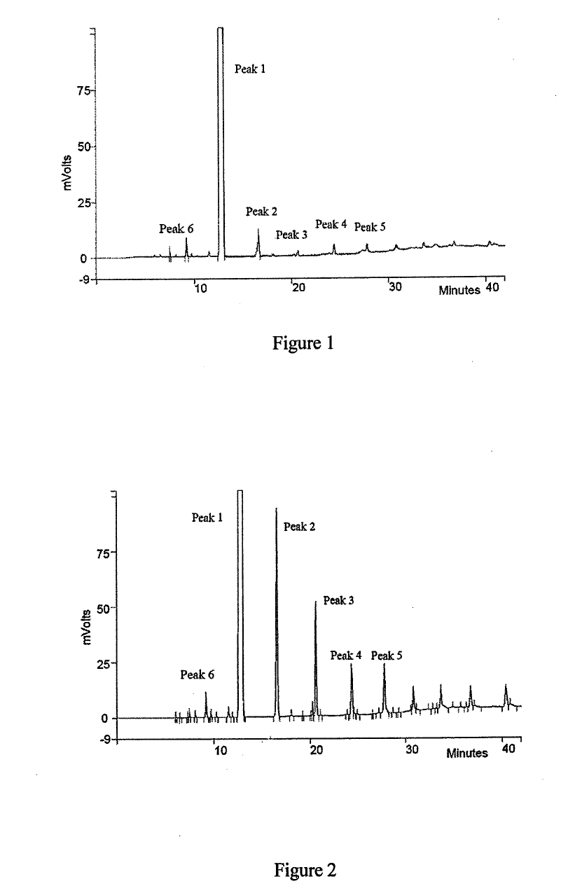

A sample was taken from the original container of tetramethyltetrasiloxane (TMCTS) for GC analysis. The chemical was purchased from Sigma-Aldrich and stored at room temperature all of the time. A sample GC chromatogram is shown in FIG. 1, and the area counts of each peak in the chromatogram are listed in Table 1. The TMCTS peak appeared at about 12 minute having a highest area count as the peak #1. A few distinct peaks appeared after TMCTS peak at a rather consistent time interval that are marked as peaks #2, #3, #4, and #5. The retention time for each peak was 12.8, 16.6, 20.6, 24.4 and 27.7 minutes respectively. Based on a preliminary analysis with GCMS, peaks 2 to 5 after the TMCTS peak may possibly be the following structures:

### Peak #2 TMCTS+(SiOCH₃H) after TMCTS lost 2H

### Peak #3 TMCTS+2(SiOCH₃H) after TMCTS lost 4H

### Peak #4 TMCTS+3(SiOCH₃H) after TMCTS lost 4H and 1CH₃

### Peal #5 TMCTS+4(SiOCH₃H) after TMCTS lost 4H and 2CH₃

The peak before the TMCTS peak as peak #6 at about 9.5 minutes may have been a chain structure of trimethyltrisiloxane, a broken TMCTS after lost one (SiOCH₃H). The higher concentration of such molecules as the peaks #2-#6 in TMCTS liquid indicated a higher possibility of polymerization.

### Example 2

### Control Sample w/o Additive

FIG. 2 shows the GC chromatograms for the sample after 7 days aging test at 110° C. It clearly shows that the sample after 7 days aging at high temperature has an increased concentration of several larger molecule species as the peak 2, peak 3, peak 4, and peak 5. Compared to the corresponding peaks for the original tetramethylcyclotetrasiloxane sample as in FIG. 2, the peak 1 at time about 12 minutes is the tetramethylcyclotetrasiloxane and doesn't have any measurable changes and, however, the peaks 2 to 5 increase tremendously. As discussed, the peaks 2 to 5 may correspond to the larger polymerized structure of tetramethylcyclotetrasiloxane molecules due to polymerization. The peak 2 may be the combination of a tetramethylcyclotetrasiloxane and a siloxane as the ring broken fragment of a tetramethylcyclotetrasiloxane molecule. Peak 3, peak 4, and peak 5 may correspond to the polymerized molecule structures of a tetramethylcyclotetrasiloxane combined with 2, 3, and 4 siloxane fragments. For a quantitative analysis, the area counts of each individual peak of GC chromatograms were collected and also listed in Table 1 for comparison. The counts of each TMCTS peak were used as the base for normalization. Any slight change in the amount of sample injection into GC resulted in a change in the area count of each chromatogram. By comparing with the corresponding blank sample chromatograms the peaks 2 to 5 were increased to 5.3, 17.6, 3.6, and 4.1 times.

### Example 3

### Tetramethylsilane (TMS)

Two samples were prepared in the same method as for samples for high temperature aging tests. The TMS was added into the two samples to 500 ppm by weight. One of the samples was also spiked with water to a concentration of 500 ppm by weight. Both of the sample ampoules were set into a silicon oil bath at 110° C. continuously for 7 days. As shown in Table 1, GC analysis indicates that the peaks 2 to 5 as in FIG. 3 for the sample without water addition increased to about 2.1 to 3.6 times based on the blank sample at room temperature, and the peaks 2 and 3 for the sample with 500 ppm water addition had the similar increase as the sample without water, and peaks 4 and 5 increased slightly more.

### Example 4

### Tetraethoxysilane

Tetraethoxysilane liquid was added into TMCTS sample to 2% by weight. The ampoule was then set into the silicon oil bath continuously for 7 days at 110° C. It was found from GC analysis that the peaks 2 and 4 as in FIG. 3 for this sample increased to above 1 time higher than those peaks for the blank sample as shown in FIG. 2, and the peaks 3 and 5 increased by about 4 times higher. However, the peaks are still much lower than those shown in FIG. 3 for TMCTS only at high temperature.

### Example 5

### 3-(methyacryloxy)propyltrimethoxysilane (MPTES)

Two samples were prepared by adding 3-(methyacryloxy)propyltrimethoxysilane liquid to the concentration of 500 ppm by weight. One of the samples was also spiked with water to a concentration of 500 ppm by weight. After aging at 110° C. for 7 days, the samples were analyzed with GC afterwards. As shown in Table 1, the peaks 2 to peak 5 as in FIG. 3 for the sample without water addition had almost the same as the peaks for the blank sample. The peaks for the sample with 500 ppm water were increased by about 0.80 to 1.7 times higher.

### Example 6

### Vinyltrimethoxysilane (VTMS)

Vinyltrimethoxysilane liquid was added into two samples to a concentration of 500 ppm by weight. One of the samples was also spiked with water to a concentration of 500 ppm by weight. Two sample ampoules were set into the silicon oil bath continuously for 7 days at 110 deg-C. The samples were analyzed with GC. It was found that the peaks 2 to peak 5 as in FIG. 3 for the sample without water addition are about 1.5 to 2.7 times in the area counts as those for the blank sample. The area counts for the chromatograms with water addition were changed about the same as the samples without water addition. For both of the samples, the area counts are still much lower than the sample without the additive addition at high temperature.

### Example 7

### Isobutylmethacrylate (IBM)

For thermal stability tests, TMCTS samples were prepared by adding 500 and 1500 ppm by weight IBM compound. In some samples, 500 ppm by weight water was added to assess any effect that water may have on inhibiting polymerization. The samples were kept at a constant temperature of either 120° C. or 132° C. for a period of 3 to 7 days.

For chemical stability tests, TMCTS samples were prepared by adding 1500 ppm by weight IBM compound, and 150 ppm by weight 29% aqueous N OH. The samples were then subjected to a constant high temperature of 120° C. for 3 to 7 days. After the tests, samples were analyzed with gas chromatography (GC) to determine chemical composition. In addition, the viscosity of the samples was tested using a viscometer. Samples containing the IBM compounds showed little to no change in composition and viscosity.

### Example 8

### Viscosity Tests

Samples of various additives with TMCTS were tested for viscosity at temperatures of 110° C. and 132° C. The samples were placed in stainless steel containers and heated for 7 days in an oil bath at the tested temperatures. Each sample contained additive at a concentration of 500 ppm by weight. Some additives (e.g. MPTMS, VTMS, IBM) were additionally tested at concentrations of 50, 100, and 200 ppm. The following additives were tested: MPTMS, VTMS, IBM, MTMS, and TEOS. As controls, TMCTS at room temperature, 20° C. (RT) and 132° C. (HT) were also tested. In addition, the samples were also tested with and without water to examine the effects of moisture on the effectiveness of each additive. Samples with water contained water at a concentration of 500 ppm. Kinematic viscosity (cSt) was measured on a capillary viscometer (Cannon-Fenske).

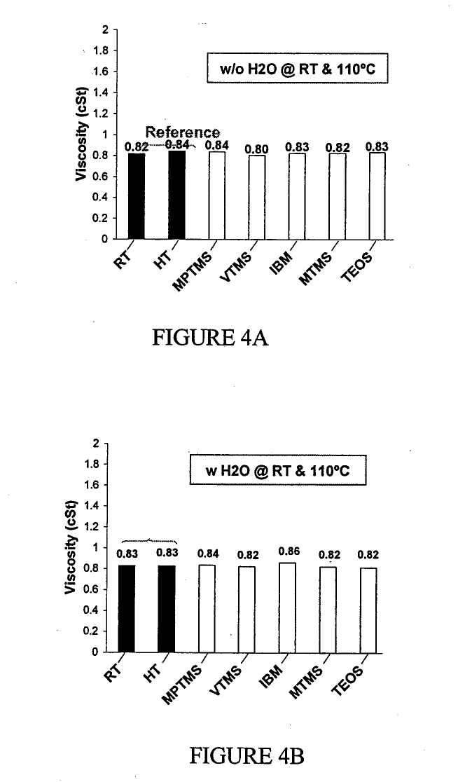

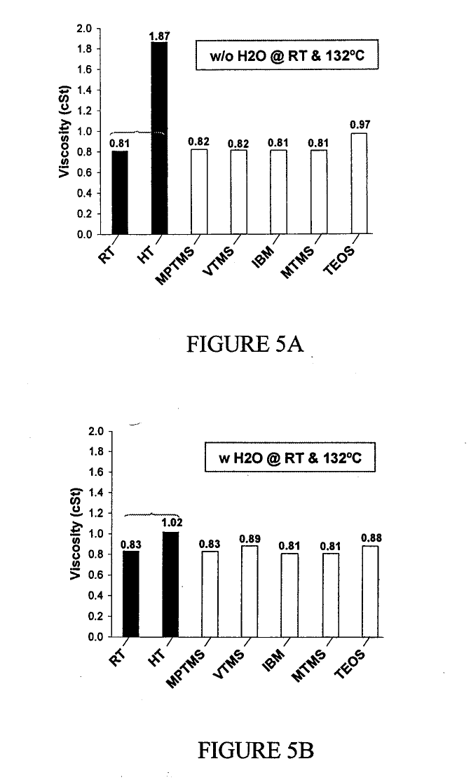

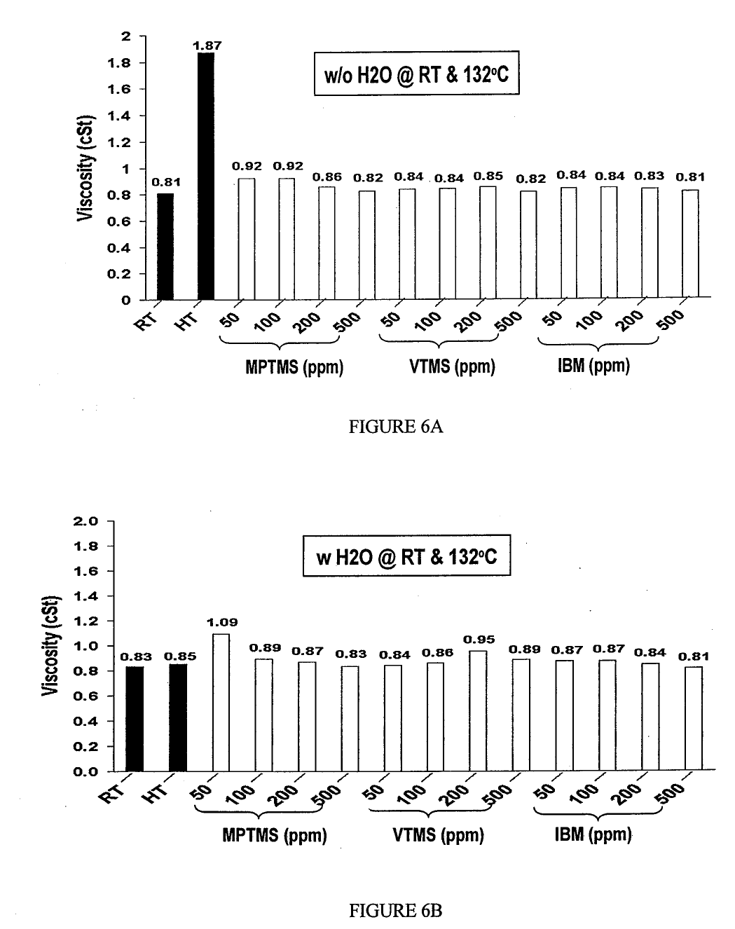

Results of the experiments are shown in FIGS. 4-6. All of the additives effectively maintained the viscosity after heating either at 110° C. or 132° C. In particular, at 132° C., the inhibitors showed marked maintenance of viscosity when compared to TMCTS without any additives. Concentration may affect the effectiveness of inhibition for some of the additives as seen in FIG. 6.

### Example 9

### Purity Tests

Samples of various additives with TMCTS were tested using gas chromatography (GC-MS) at temperatures of 132° C. The samples were placed in stainless steel containers and heated for 7 days in an oil bath at the tested temperatures. The concentration of the additives was varied at concentrations of 50, 100, and 200 ppm. The following additives were tested: MPTMS, VTMS, and IBM. As controls, TMCTS at room temperature (RT) and high temperature, 132° C., were also tested. The percentage of area under peaks corresponding to the main TMCTS peak (i.e. impurities) was measured after heating at 132° C. for each sample tested. Results of the experiment are shown in Table 2.

TABLE 2

| | | | TMCTS area | TMCTS area |
|---|---|---|---|---|
| Temperature | | Concentration | count (%) w/o | count (%) w/ |
| (C.) | Additive | (ppm by wt) | water | water |
| 25 | No | 0 | 99.5 | 99.26 |
| 132 | No | 0 | 98.94 | 97.64 |
| 132 | MPTMS | 50 | 99.34 | 94.79 |
| 132 | MPTMS | 100 | 99.23 | 99.22 |
| 132 | MPTMS | 200 | 99.28 | 99.15 |
| 132 | MPTMS | 500 | 99.22 | 99.01 |
| 132 | VTMS | 50 | 99.49 | 98.38 |
| 132 | VTMS | 100 | 99.32 | 98.45 |
| 132 | VTMS | 200 | 99.17 | 97.01 |
| 132 | VTMS | 500 | 99.42 | 97.39 |
| 132 | IBM | 50 | 99.1 | 99.32 |
| 132 | IBM | 100 | 99.05 | 99.32 |
| 132 | IBM | 200 | 99.15 | 99.12 |
| 132 | IBM | 500 | 99.02 | 99.01 |

As can be seen in the data from Table 2, all of the tested additives showed excellent inhibition of polymerization of the TMCTS without water added, as noted by the high purity percentages. At all concentrations, none of the tested additives caused the purity of TMCTS to dip below 99% purity. However, with the addition of moisture, some additives showed better results than others. Concentration also may play a larger role in TMCTS stabilization with water added. IBM and MPTMS showed superior results in inhibiting polymerization in the presence of water than VTMS.

While embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. A method of stabilizing one or more cyclotetrasiloxane compounds for silicon film deposition comprising:
adding one or more additives to the one or more cyclotetrasiloxane compounds to inhibit polymerization of the cyclotetrasiloxane compound, wherein the one or more additives comprises an acrylate; a methacrylate; a silane compound having the following formula: 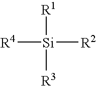
wherein R¹-R⁴ may each independently be an alkyl group, an alkoxy group, a heterocyclic group, an acryloxy group, a vinyl group, an epoxy group, a glycidyloxy group, or a hydrogen, and wherein R¹-R⁴ may be the same or different from each other; or combinations thereof.

2. The method of claim 1 wherein said one or more additives is added to the one or more cyclotetrasiloxane compounds in an amount effective to maintain the viscosity of the one or more cyclotetrasiloxane compounds at a temperature of at least 110° C. within about 10% of the viscosity of the one or more cyclotetrasiloxane compounds at 20° C.

3. The method of claim 2 wherein the amount is effective to maintain the viscosity of the one or more cyclotetrasiloxane compounds at a temperature of at least 132° C. within about 10% of the viscosity of the one or more cyclotetrasiloxane compounds at 20° C.

4. The method of claim 1 wherein said one or more additives is added to the one or more cyclotetrasiloxane compounds in an amount effective to maintain the purity of the one or more cyclotetrasiloxane compounds at a purity of at least 99% as measured by gas chromatography at a temperature of at least 110° C.

5. The method of claim 4 wherein the amount is effective to maintain the purity of the one or more cyclotetrasiloxane compounds at a purity of at least 99% as measured by gas chromatography at a temperature of at least 132° C.

6. The method of claim 1 wherein the cyclotetrasiloxane compound has the following formula: 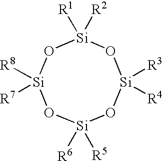
wherein R¹-R⁸ may independently be an alkyl group or hydrogen, and R¹-R⁸ may be the same or different from one another.

7. The method of claim 6 wherein the alkyl group contains from 1 to 4 carbons.

8. The method of claim 1 wherein the cyclotetrasiloxane compound is tetramethyl cyclotetrasiloxane.

9. The method of claim 1 wherein the cyclotetrasiloxane compound is octamethyl cyclotetrasiloxane.

10. The method of claim 1 wherein the alkoxy group comprises a methoxy group, an ethoxy group, a propoxy group, or a butoxy group.

11. The method of claim 1 wherein at least three of R¹-R⁴ comprises an alkoxy group.

12. The method of claim 1 wherein R¹-R⁴ all comprise the same alkyl group.

13. The method of claim 1 wherein the alkyl group contains from 1 to 8 carbon atoms.

14. The method of claim 1 wherein the silane compound comprises tetramethylsilane, tetraethylsilane, tetrapropylsilane, vinyltrimethoxysilane, methacryloxytrimethylsilane, or methacryloxypropyltrimethoxysilane.

15. The method of claim 1 wherein the silane compound is an orthosilicate having the following formula: 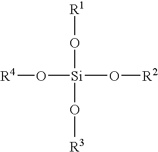
wherein R¹-R⁴ may each independently be an alkyl group or a hydrogen atom, and wherein R¹-R⁴ may be the same or different from one another.

16. The method of claim 15 wherein the alkyl group contains from 1 to 8 carbons.

17. The method of claim 15 wherein the orthosilicate is tetraethylorthosilicate, tetramethylorthosilicate, tetrabutylorthosilicate, or tetrapropylorthosilicate.

18. The method of claim 1 wherein the acrylate has the following formula: 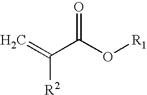
wherein R¹-R² may each independently be an alkyl group or a hydrogen atom, and wherein R¹-R² may be the same or different from one another.

19. The method of claim 18 wherein R² is a methyl group.

20. The method of claim 18 wherein R¹ is an alkyl group having from 1 to 24 carbon atoms.

21. The method of claim 18 wherein R¹ comprises a methyl group, an ethyl group, a propyl group, an isopropyl group, a butyl group, or an isobutyl group.

22. The method of claim 1 wherein the methacrylate is isobutyl methacrylate.

23. The method of claim 1 wherein the one or more additives is added at a concentration ranging from about 10 ppm to about 2000 ppm by weight.

24. The method of claim 1 wherein the one or more cyclotetrasiloxane compounds contain water.

25. The method of claim 24 wherein the one or more cyclotetrasiloxane compounds contain water at a concentration ranging from about 1 ppm to about 2000 ppm.

26. A silicon film deposition composition comprising:
a mixture of one or more cyclotetrasiloxane compounds and one or more additives, said additives comprising an acrylate; a methacrylate; a silane having the following formula: 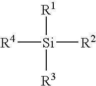
wherein R¹-R⁴ may each independently be an alkyl group, an alkoxy group, a heterocyclic group, an acryloxy group, a vinyl group, an epoxy group, a glycidyloxy group, or a hydrogen, and wherein R¹-R⁴ may be the same or different from each other; or combinations thereof.

27. The composition of claim 26 wherein said one or more additives is selected from the group consisting of tetramethylsilane, tetraethylsilane, tetrapropylsilane, vinyltrimethoxysilane, methacryloxytrimethylsilane, methacryloxypropyltrimethoxysilane, isobutylmethacrylate, tetraethylorthosilicate, tetramethylorthosilicate, tetrabutylorthosilicate, tetrapropylorthosilicate and combinations thereof.

28. The composition of claim 26 wherein said one or more additives is at a concentration effective to maintain a viscosity of no more than 1 cSt at a temperature of at least 110° C.

29. The composition of claim 26 wherein said one or more additives is at a concentration effective to maintain a viscosity of no more than 1 cSt at a temperature of at least 132° C.

30. The composition of claim 26 wherein said one or more additives is at a concentration effective to maintain 99% purity of the one or more cyclotetrasiloxane compounds at a temperature of at least 110° C.

31. The composition of claim 26 wherein said one or more additives is at a concentration effective to maintain 99% purity of the one or more cyclotetrasiloxane compounds at a temperature of at least 132° C.

32. The composition of claim 26 wherein said one or more additives is at a concentration ranging from about 10 ppm to about 2000 ppm by weight.
